(19) United States
(12) Patent Application Publication
(10) Pub. No.: US 2005/0082110 A1
(43) Pub. Date: Apr. 21, 2005

(54) Venting apparatus for increasing the flow of air through an enclosure

(76) Inventor: Marek Golebiowski, Lombard, IL (US)

Correspondence Address: CATERPILLAR INC.;100 N.E. ADAMS STREET, PATENT DEPT., PEORIA, IL, 616296490, US

(21) Appl. No.: 10/687,018

(22) Filed: Oct. 16, 2003

(51) Int. Cl. F01N 1/00; G10K 11/04

(52) U.S. Cl. 181/204; 181/200

(57) ABSTRACT

The engine compartment includes an engine enclosure and a venting apparatus in fluid communication the engine enclosure. The venting apparatus includes a throat portion and a venting device.

### TECHNICAL FIELD

This invention relates generally to an engine compartment and, more particularly, to a venting arrangement for venting the engine compartment air of a work machine.

### BACKGROUND

With the increase in governmental regulations related to controlling the amount of particulate matter and noise released into the environment, it becomes a high priority for manufactures of engines to comply with regulations set forth by the various governmental regulatory authorities. One of the problems associated with the development of engines to meet the stringent emissions regulations is heat build-up in the engine enclosure. However, because of the various regulations related to limiting the amount of noise emanating from engines, it is essential to have engine enclosures that are well insulated which may also contribute to the adverse result of increasing the temperature within the engine compartment. Engines that use Exhaust Gas Recirculation (EGR) technology for meeting EPA regulations add to the heat build-up because hot exhaust gases are reintroduced into the engine. Finally, the specific configuration of the machine can reduce the volume of air entering the enclosure from the bottom of the vehicle such as, for example, attaching bellygaurds to the bottom of the machine. All these are just some of the variables that contribute to the heat build up in the engine enclosure.

To counteract this heat build up, fans could be added, but this would be counterproductive because the fans themselves could produce not only additional noise but additional heat as well, which adds to the heat build-up. Another measure that could be taken is to increase the number of ways air can enter and exit the enclosure. This alternative may be counterproductive in that increasing the number of openings in the engine compartment may both increase noise levels and decrease the rigidity of the enclosure.

One prior art attempts to vent air from the compartment can be found in U.S. Pat. No. 3,866,580, issued Feb. 18, 1975, to Gerald E. Whitehurst, which discloses an air-cooled enclosure for an engine. Although Whitehurst discloses an apparatus that increases the airflow out of the compartment, he fails to teach a configuration that optimizes the pressure differential in the venting device, which would increase the volume of air ventilated through the engine compartment.

The present invention is dedicated to overcoming one or more of the problems set forth above.

### SUMMARY OF THE INVENTION

In accordance with an embodiment disclosed herein, an engine compartment that includes an engine enclosure, a venting apparatus in fluid communication the engine enclosure, and wherein the venting apparatus includes a throat portion and a venting device.

In accordance with another embodiment disclosed herein, an engine compartment includes a venting apparatus having a throat portion. The venting apparatus has geometry, which increases the pressure differential at a location within the venting apparatus resulting in the higher rate of flow of engine compartment air from the engine compartment.

A method of venting engine compartment air from an engine enclosure using a source of pressurized air. The engine compartment includes a venting apparatus having a throat portion. The method comprises the steps of discharging pressurized exhaust gas from the source of pressurized air into the venting apparatus, creating a pressure differential in the venting apparatus at the throat portion, and drawing said engine compartment air into the venting apparatus as a result of the pressure differential.

### BRIEF DESCRIPTION OF THE DRAWINGS

FIG. 1 is a diagrammatical view of an embodiment of the venting apparatus;

FIG. 2 is a diagrammatical view of an embodiment of the venting device for use with an embodiment of the venting apparatus; and

FIG. 3 is a diagrammatical view of another embodiment of the venting device for use with an embodiment of the venting apparatus.

### DETAILED DESCRIPTION

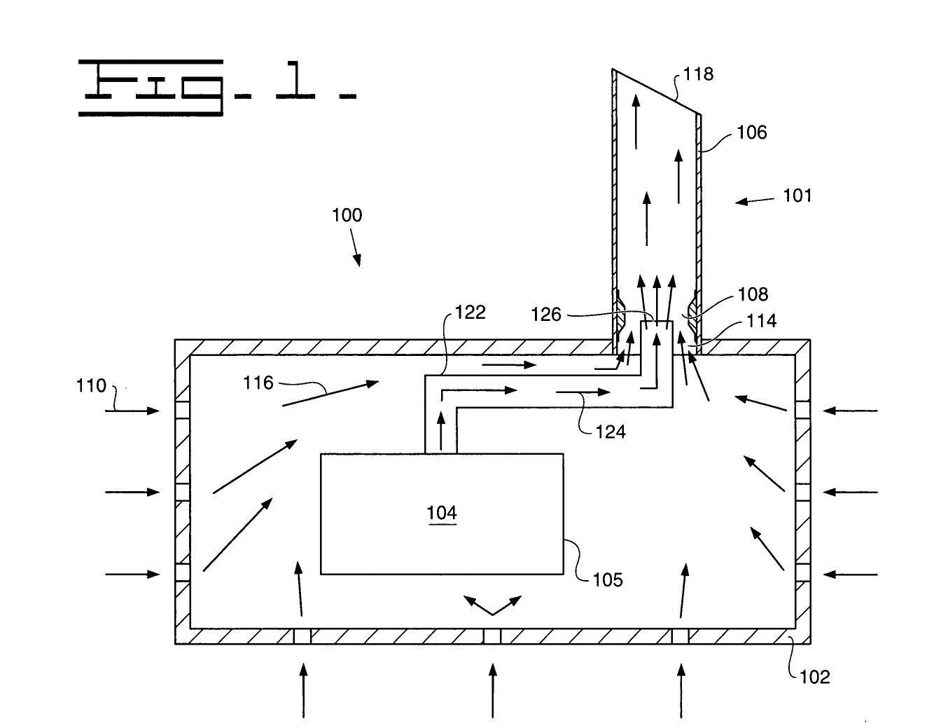

Shown in FIG. 1 is an engine compartment 100 of a vehicle (not shown), comprising an embodiment of a venting apparatus 101, an engine enclosure 102, and a source of pressurized air 104, which in the embodiment shown is an engine 105. The venting apparatus 101 in fluid communication with the engine enclosure and comprises a venting device 106 and a throat portion 108.

The engine enclosure 102 is structured to have sufficient rigidity to support the venting apparatus 101 and to allow ambient air 110 to infiltrate the engine enclosure 102. The engine enclosure 102 is provided with an exhaust port 114 to provide a location of egress of engine compartment air 116 out of the engine enclosure 102. The venting device 106 is substantially hollow and is coupled to the engine enclosure 102 by welding, mechanical fasteners, or other like methods, and is located so as to overlie exhaust port 114. In the present embodiment, the throat portion 108 is coupled to the venting device 106. As used herein, “throat portion” is defined as a cross-sectional area in the venting device, in which the area for the passage of air is less than the adjacent cross-sectional area for the passage of air. As should be apparent by those of ordinary skill in such art, the throat portion 108 forms a constriction in the venting device 106, thereby producing a “venturi effect”, which causes an increase in velocity of air flow and a corresponding decrease in pressure of the flowing air within the throat portion. As shown, the throat portion 108 is structured and arranged as to provide the cross-section of the venting apparatus 101 with a substantially hourglass shape.

As noted above, the engine 105 serves as a source of pressurized air 104 and discharges, for example, pressurized exhaust gas 124. However, it is contemplated that other sources of pressurized air 104 such as a pump, fluid capacitor, or other like sources, which may be located within, or external to the engine enclosure 102, may be utilized without deviating from the spirit of the present invention. An exhaust device 122, in fluid communication with the engine 105, is used to transport the pressurized exhaust gas 124 from the engine 105 to the venting apparatus 101. The exhaust device 122 has a diameter that is less than the diameter of the venting device 106 and includes an end 126 that is located upstream of the throat portion 108. As illustrated in the embodiment shown, the end 126 of the exhaust device 122 is located approximately 10 mm upstream of the smallest cross-sectioned area of the throat portion 108. However, depending on various factors, for a particular installation, the end 126 of the exhaust device 122 may be located anywhere from below, but in close proximity, to the smallest cross-sectional area of the throat portion 108, to substantially above the smallest cross-sectional area of the throat portion 108. Locating the end 126 of the exhaust device 122 as described above will produce a venturi effect such that engine compartment air 116 will be drawn from the engine enclosure 102 into the venting apparatus 101, thereby venting the heated engine enclosure 102 air from the engine enclosure 102 and allowing that air to be replaced with cooler air. Further discussion of the venturi effect will follow.

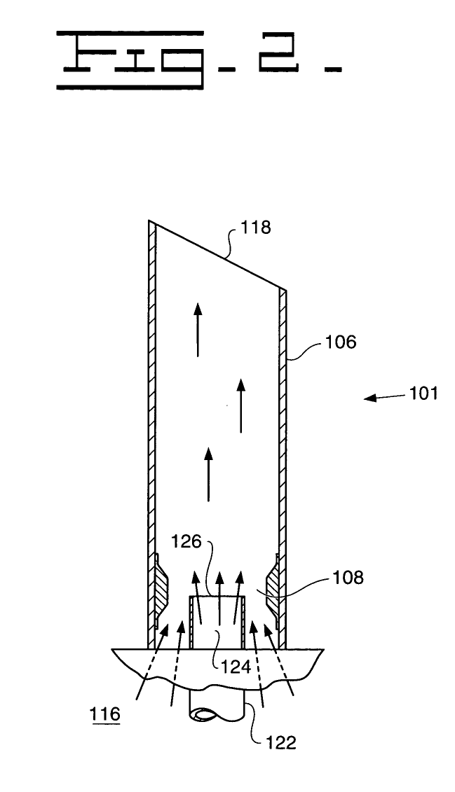

Looking now at FIG. 2, engine exhaust air 124 flows out of the exhaust device 122 and passes through the throat portion 108 prior to being exhausted out of the end 118 of the venting device 106 to the outside air. The throat portion 108 constricts the engine exhaust air 124, which in turn increases the velocity by decreasing the pressure of the air 124 at the throat portion 108. The decrease in air pressure at the throat portion 108 creates an air pressure differential between the engine compartment air 116 and the air at the throat portion 108. The higher pressured engine compartment air 116 will have the tendency to move towards the lower pressured air at the throat portion 108.

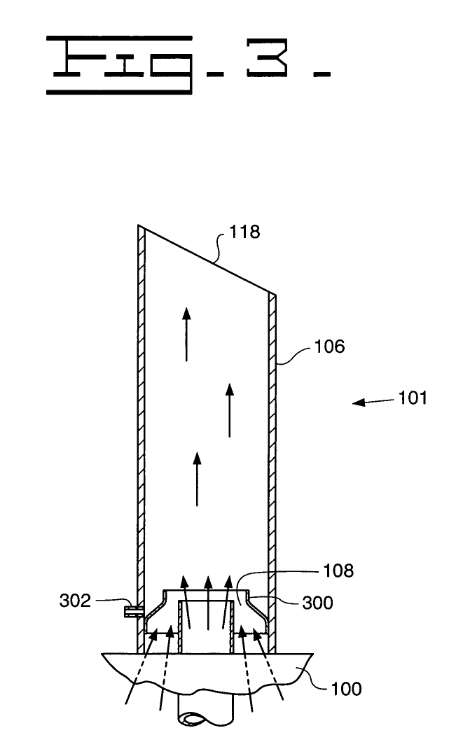

FIG. 3 is a diagrammatical view of an alternate embodiment of the venting arrangement 101. The throat portion 108 provides the cross section of the venting apparatus 101 with half an hourglass shape. The throat portion 108 is structured and arranged to provide a gutter 300 around the inner radial circumference of the venting device 106. The venting apparatus 101 includes a drain member 302 coupled to the venting device 106, and the drain member 302 is in fluid communication with the gutter 300.

### Industrial Applicability

The pressurized exhaust gas 124 is generated from the engine 105. The exhaust device 122, coupled to the engine 105, forms a path for the pressurized air 124 to travel from the engine 105 to the venting apparatus 101. The exhaust device 122 has an end portion 126 that terminates upstream from the throat portion 108. The pressurized air 124 is constricted as it moves through the throat portion 108 and the venting device 106, thus creating a pressure differential at the throat portion 108, which increases the velocity of the air 124, as it travels across the throat portion 108. The pressure differential creates what is known as a “venturi effect” within the venting apparatus 101. This “venturi effect” draws the higher pressured engine compartment air 116 into the venting apparatus 101, in turn increasing the volume of engine compartment air 116 being ventilated. The throat portion 108 as embodied herein has a geometry of a hourglass shape, which increases the pressure differential at the location the venting device 106, resulting in a higher rate of flow of engine compartment air 116 from the engine enclosure 102.

The increase in air being drawn into the venting apparatus 101 increases the volume of air moving through the engine enclosure 102. For example, venting begins when the engine 120 is started. The radiant heat from the engine heats the engine compartment air 116 in the engine enclosure 102. The engine 105, when in operation, produces pressurized exhaust gas 124, which moves through the exhaust device 122, eventually discharging within the venting apparatus 101. The discharged air is immediately constricted by the throat portion 108, thereby creating a pressure differential immediately upstream from the end portion of the exhaust device 126. The lower pressure, in turn, draws the relatively higher pressured engine compartment air 116 into the venting apparatus 106 from the engine compartment 100, whereby engine compartment air 116 and exhaust air 124 are mixed. The mixed air passes through the venting device 106 and discharges out the end 118. This increase in the volume of engine compartment air 116 being drawn out of the engine enclosure 102 increases the flow of cooler ambient air 110 drawn into the engine enclosure 102, thereby creating a “draft” in the engine enclosure 102. The “draft” air absorbs heat, in effect reducing the heat build-up in the engine enclosure 102.

In the alternate embodiment the gutter 300 collects contamination, such as water, soot, or soil, and prevents any such contaminate of flowing into the engine compartment 100 through the end 118 of the venting device 106. The contamination is then expelled out of the venting apparatus 106 through the drain member 302 coupled to the venting device 106.

Other aspects, objects and advantages of this invention can be obtained from a study of the drawings, the disclosure, and the appended claims.

1. An engine compartment, comprising:
an engine enclosure;
a venting apparatus in fluid communication with said engine enclosure; and
wherein said venting apparatus includes a venting device and a throat portion.

2. The engine compartment of claim 1, further including a source of pressurized air in communication with said venting apparatus.

3. The engine compartment of claim 2, wherein said source of pressurized air is an engine, said engine being at least partially located in said engine enclosure.

4. The engine compartment of claim 1, wherein said source of pressurized air comprises an exhaust device having an end portion located substantially upstream of said throat portion.

5. The engine compartment of claim 1, wherein said venting apparatus has a cross-section of a substantially hourglass shape.

6. The engine compartment of claim 1, wherein said venting apparatus includes:
a gutter; and
a drain member in fluid communication with said gutter.

7. An engine compartment, comprising:
an engine enclosure;
a venting apparatus in fluid communication with said engine enclosure, said venting apparatus includes a throat portion; and
wherein said venting apparatus includes a geometry which increases the pressure differential at a location within the venting apparatus resulting in a higher rate of flow of engine compartment air from said engine enclosure.

8. The engine compartment of claim 7, including a source of pressurized air in communication with said venting apparatus.

9. The engine compartment of claim 8, wherein said source of pressurized air comprises an engine.

10. The engine compartment of claim 8, wherein said source of pressurized air discharges pressurized exhaust gas through said venting apparatus.

11. The engine compartment of claim 8, wherein the said source of pressurized air has an exhaust device having an end portion located substantially upstream of said throat portion.

12. A method of venting engine compartment air from an engine compartment using a source of pressurized air, the engine compartment includes a venting apparatus having a throat portion, comprising the steps of:
discharging pressurized exhaust gas from the source of pressurized air into the venting apparatus;
creating a pressure differential in the venting apparatus at the throat portion; and
drawing said engine compartment air into the venting apparatus as a result of the pressure differential.

13. A method of claim 12, wherein said source of pressurized air is an engine, and said step of discharging pressurizes exhaust gas is through an exhaust device coupled to said engine.
